(19) United States
(12) Patent Application Publication
(10) Pub. No.: US 2019/0320846 A1
(43) Pub. Date: Oct. 24, 2019

(54) HORIZONTAL GRIDDLE WITH AUTOMATIC DISPENSING

(71) Applicant: Enodis Corporation, New Port Richey, FL (US)

(72) Inventors: Roberto Nevarez, Hudson, FL (US); Douglas S. Jones, New Port Richey, FL (US)

(21) Appl. No.: 16/388,345

(22) Filed: Apr. 18, 2019

Related U.S. Application Data
(60) Provisional application No. 62/661,850, filed on Apr. 24, 2018.

(51) Int. Cl. A47J 37/04; A23L 5/10

(52) U.S. Cl. CPC A47J 37/044; A23V 2002/00; A23L 5/15

(57) ABSTRACT

A cooking apparatus having a conveyor system having a continuous cooking surface and a dispenser disposed proximate the continuous cooking surface. The cooking apparatus also having a guide disposed between the dispenser and the continuous surface to guide food product released from dispenser to the continuous cooking surface; and at least one platen proximate the cooking surface to cook the food product. A method of cooking using a cooking apparatus by dispensing a food product from a food dispenser and receiving the food product onto a continuous cooking surface and moving the cooking surface between a first platen and a second platen to cook the food product. The conveyor mechanism is indexed to move at a same rate as said food dispenser and indexes the appropriate distance to convey the food product to a position centered beneath upper cooking platen.

This application claims the benefit to U.S. Provisional Application No. 62/661,850 filed on Apr. 24, 2018, the entire contents of which are incorporated herein by reference

### BACKGROUND OF DISCLOSURE

### 1. Field of the Disclosure

This disclosure relates to a horizontal griddle for heating food from an automatic dispenser.

### 2. Discussion of the Background Art

Grill apparatus have heretofore been made for automatic two-sided grilling of hamburger patties. In the grill apparatus disclosed in U.S. Pat. Nos. 3,965,807; 3,987,718 and 4,444,094, the hamburger patties are conveyed by an endless type conveyor from a loading station at one side of the grill between upper and lower cooking platens and then discharged at a discharge station at the other side of the grill. In U.S. Pat. Nos. 3,965,807 and 3,987,718, the patties are conveyed in continuous fashion from the loading station between the cooking platens to the discharge station. In U.S. Pat. No. 4,444,094, the conveyor is intermittently operated to advance uncooked patties from a loading station at one end of the grill onto the lower platen. The conveyor is then stopped for a cooking period while the patties are above the lower platen and the upper platen is lowered while the conveyor is stopped to cook the patties on both sides. The upper platen is thereafter raised and the conveyor again operated to advance the cooked patties off the lower platen to a discharge station at the other end of the grill.

Such prior automatic two-sided hamburger grills in which the hamburger patties were loaded at one end of the grill and discharged at the other end of the grill, required operator working space at both ends of the grill and also made it difficult for a single operator to both load uncooked patties at the inlet end of the grill and retrieve cooked hamburger patties at the discharge end.

U.S. Pat. No. 4,567,819 provided a hamburger grill in which a conveyor is operated in one direction to advance uncooked hamburger patties from a loading station at the front of the grill to a position between upper and lower cooking platens for cooking of the patties, and in which the conveyor is thereafter operated in the opposite direction to advance the cooked patties back to the front of the grill for discharge to a cooked patty receiver at the front of the grill. This grill apparatus provided for two-sided grilling of hamburger patties which minimizes the floor space and overhead clearance required for the grill apparatus.

### SUMMARY OF THE DISCLOSURE

The present disclosure overcomes the disadvantages of the prior art by providing automatic dispensing of food products onto a conveyor for rapid cooking of multiple piece of food products, i.e., small foot print. The present disclosure has the unique advantages over the prior art grills in that it provides automatic dispensing of fresh, frozen, thawed, or partially cooked product, the grill is intelligently linked to the dispensing system to automatically cook food for the proper time and temperature, and the grill provides product height recognition controls. The control of the present disclosure will be internal to the grill and will control dispenser, upper and lower platen temperatures, holding area temperature, conveyor drive motor (indexing) and cook timing. The control will also have product recognition technology.

A cooking apparatus having a conveyor system having a continuous cooking surface and a dispenser disposed proximate the continuous cooking surface. The cooking apparatus also having a guide disposed between the dispenser and the continuous surface to guide food product released from the dispenser to the continuous cooking surface; and at least one platen proximate the cooking surface to cook the food product.

A cooking apparatus having a first platen and a second platen disposed in spaced apart relation to one another for cooking a food product is also provided. The cooking apparatus further providing a conveyor system having a continuous cooking surface that moves between the first platen and the second platen. A dispenser disposed proximate said continuous cooking surface is indexed to move at a same rate as said dispenser to provide food product placement on cooking surface.

A method of cooking using a cooking apparatus by dispensing a food product from a food dispenser and receiving the food product onto a continuous cooking surface of a conveyor mechanism is further provided. The method also includes moving the cooking surface between a first platen and a second platen to cook the food product. The food product is deposited onto a tray after being cooked, wherein the conveyor mechanism is indexed to move at a same rate as said food dispenser and indexes the appropriate distance to convey the food product to a position centered beneath upper cooking platen.

### BRIEF DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a front-right side perspective view of the horizontal griddle with automatic dispensing, according to the present disclosure.

FIG. 2 is a front-right side perspective view of the horizontal griddle of FIG. 1 without the dispensing unit and with the upper platen in a lowered cooking position, according to the present disclosure.

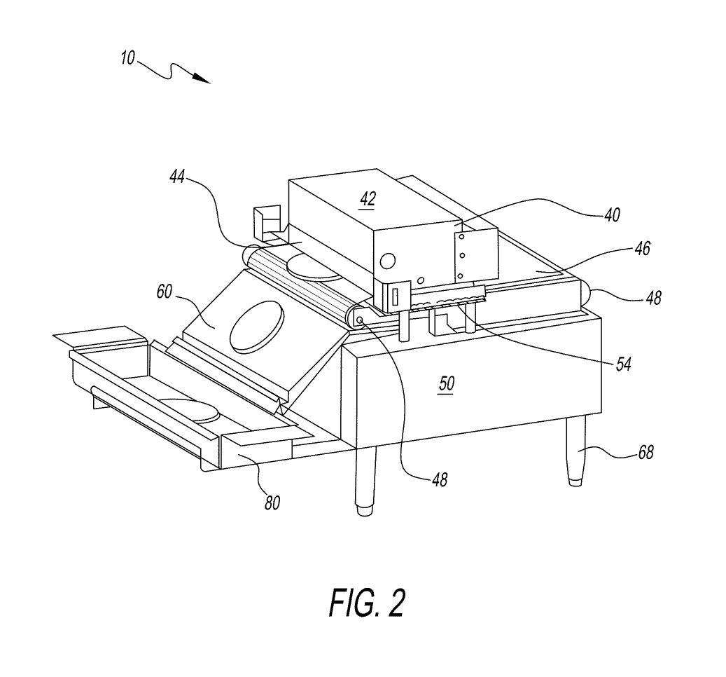

FIG. 3 is a front-right side perspective view of the horizontal griddle of FIG. 1, with the platen in an upper or raised non-cooking position, according to the present disclosure.

FIG. 4 is a front-side perspective view of the horizontal griddle of FIG. 1 having a portion of the dispenser cut away to illustrate a cross-sectional view of the dispenser.

FIG. 5 is a front view of a food handling system with the food dispensing assembly stored within a food storage assembly.

FIG. 6 is a front view of the food handling system with the food dispensing assembly deployed in the dispensing configuration.

FIG. 7 is a perspective view of a food product hygienically encased within a continuous laminated food strip.

FIG. 8 is a partial exploded view of the upper portion of the food product storage enclosure or carton showing the food dispensing assembly.

FIG. 9 is a partial detailed schematic front view of the food dispensing assembly deployed in the dispensing configuration.

FIG. 10 is a partial perspective view of the food dispensing assembly deployed in the dispensing configuration.

FIGS. 11a through 11c schematically depict different dispositions of the film strip take-up devices relative to the food strip directional control.

FIG. 12 is a front-right side perspective view of the horizontal griddle of FIG. 1, having the dispensing unit under a remainder of griddle 10, according to the present disclosure.

### DESCRIPTION OF THE PREFERRED EMBODIMENT

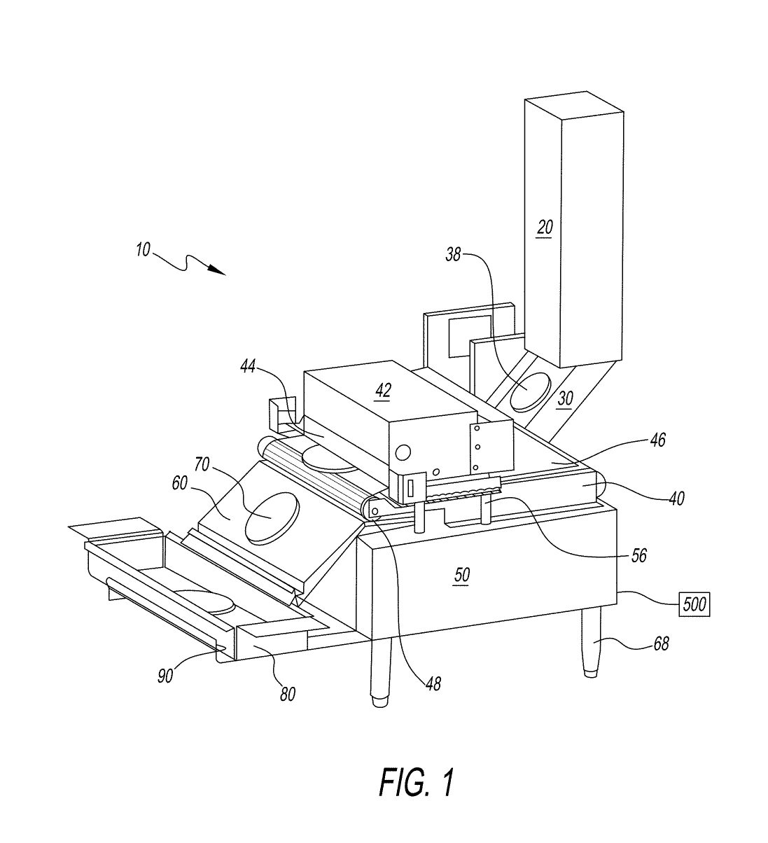

Referring to FIG. 1, a horizontal griddle 10 for commercial food preparation, is shown. FIG. 1 shows a single griddle 10, however, multiple griddles 10 can be combined/added on to meet throughput needs of any application. Griddle 10 has a product guide 30 for receiving food product 38, e.g. a meat, chicken or fish patty, from a dispensing container or magazine 20. Griddle 10 can accommodate all protein states: fresh, frozen, thawed. Accordingly, food product 38 alternatively can be a food product of any protein state: fresh, frozen thawed, etc., for example, frozen food 38 can be a fresh meat hamburger patty.

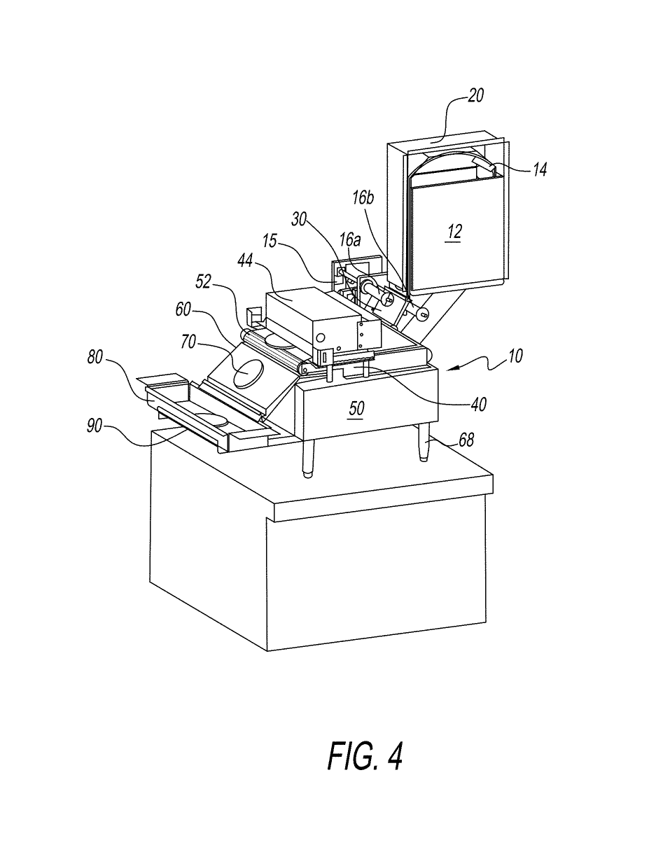

One example of magazine 20 is shown in FIG. 4, however, griddle 10 can be used with other dispensing containers or magazines that can dispense food product 38 onto product guide 30 or without any dispensing containers or magazines.

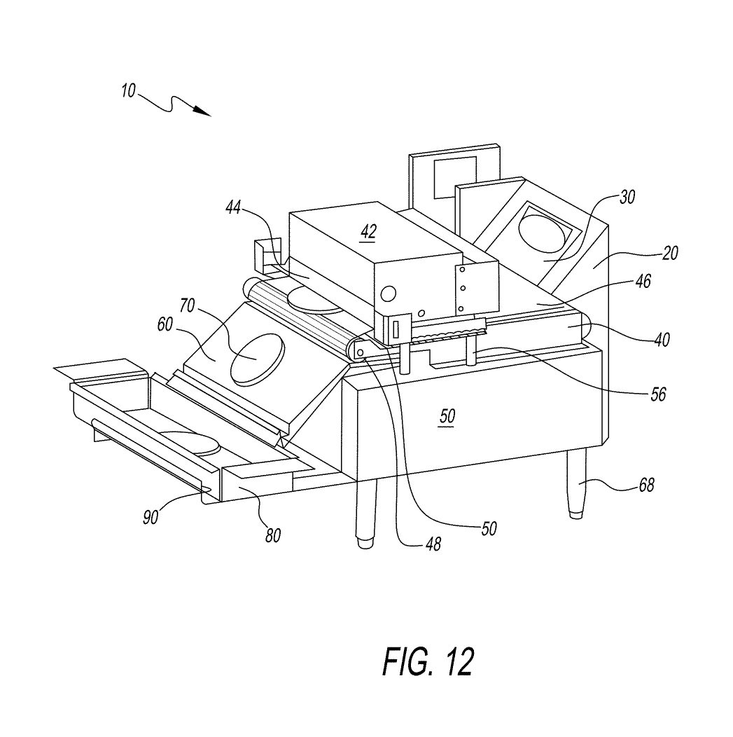

Referring to FIG. 4, magazine 20 contains a food storage bin 12, such as a cardboard box commonly used for food storage. As shown in FIG. 12, magazine 20 of the dispensing unit can alternatively be positioned under a remainder of griddle 10 for maximum compactness. Bin 12 is generally a cardboard box that holds a predetermined number of pieces of food or patties, for example. Food product 38 is arranged between two sheets of mylar tm film or strips 14 that are pre-folded and placed in bin 12 for commercial food preparation. Griddle 10 has a cooking region 40 that is mounted on support structure 50. Support structure 50 rests on legs 68. Extending from cooking region 40 is a chute 60 to transport cooked food 70 to a bin 80. Bin 80 is supported by arm 90 that extends from lower surface of support structure 50.

Referring to FIG. 1, magazine 20 deposits food product 38, for example, a meat patty onto guide 30. Guide 30 is elevated and at an angle relative to cooking region 40 and cooking surface 52. Proximate guide 30, preferable to the front and to the rear of guide 30 are two motorized take-up reels, front take-up reel 16a and rear take-up reel 16b. Take-up reels 16a and 16b are each configured to have a slot therein, into which one of mylar strips 14, one from top surface of food product 38 and one from bottom surface of food product 38, are fed. Reals 16a and 16b are motorized to automatically, wind mylar film during cooking operation to release food products 38 and allow them to freely fall onto guide 30 and onto cooking surface 52. While magazine 20 is shown dispensing food product 38 that is a flat circular meat patty, any shape and type of food could also be dispensed by magazine 20 onto guide 30 in preparation for cooking in cooking region 40.

Each take-up real 16a and 16b is motorized by a motor 15 that, preferable rotate in opposite directions, e.g. clockwise and counter-clockwise to wind mylar strips during release of food product 38. Motor 15 is indexed to move at the same rate as cooking surface 52 of conveyor system 46 to ensure that released food product 38 is properly received and spaced beneath platens 44 and 54 for proper cooking.

Cooking region 40 includes a housing 42 that houses upper platen 44. Cooking region 40 also includes an endless conveyor system 46 that is supported and moved by rollers 48. Immediately beneath surface 52 of conveyor system 46 is a lower platen 54 that heats food 40 from below its surface. Using a first or lower platen 54 and a second or upper platen 44, the food will be thoroughly cooked, thus preventing and/or greatly reducing the possibility of contamination. Additionally, platens 44, 54, reduce the likelihood that food product 38 will be unevenly cooked or burned on either a top or bottom surface of the patty. Further, the platens 44, 54 allow patties to pass through the cooking region 40 at a rapid rate because the overall cooking time is reduced. Thus, a greater number of patties can be cooked at a single time making the overall cooking process more efficient.

Housing 42 and upper platen 44 are adjustable relative to surface 52 of conveyor system 46 on posts 56 to accommodate different heights of meat patties or other food product 38 during the cooking process. The adjustability also allows for different styles of cooking of the food such as searing, char-grilling, etc. Housing 42 can be elevated using pneumatic devices including valves or small motors or any other such mechanism commonly used for such purposes. Housing 42 contains electronics for controlling its vertical movement of housing 42 on posts 56.

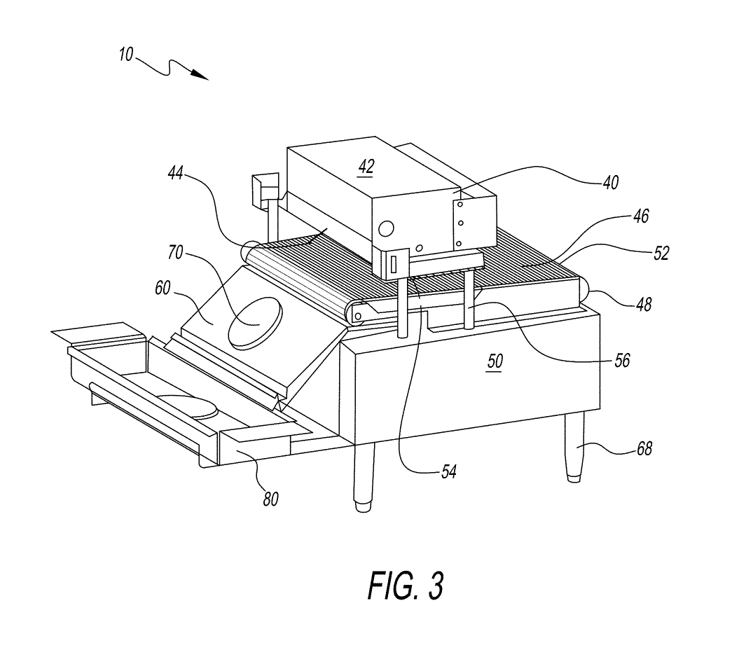

Referring to FIG. 3, housing 42 and upper platen 44 are shown in a raised position on posts 56. The raised position allows for clearance of food product 38 during the cooking process on surface 52 of conveyor system 46.

Housing 42 also contains automatic product recognition electronics used to adjust the cooking position of second or upper platen 44 into proper cooking position with regard to the food product 38 to be cooked. Upper platen 44 and lower platen 54 are disposed in a spaced apart relationship above and below cooking surface 52, respectively. A positioning mechanism, preferably a motor, is located within housing 42, and moves the platen 44 toward and/or away from food product 38. Housing 42 also contains a detector equipped with a sensor that monitors the current of motor. The sensor provides a signal to a controller in response to a change in the load on the motor, such as, when platen 44 makes contact with a food product disposed on the conveyor belt above first platen. The controller responds to the signal to move the positioning mechanism connected to platen 44 into a cooking position in relation to the food product 38. Based upon the, for example, the height or thickness or food product 38 or distance traveled by platen 44, one of a plurality of pre-stored cook procedures is selected to cook food product 38.

The detector comprises a device that is selected from the group consisting of a micro switch, proximity sensor, touch sensor, strain sensor, thermal sensor, optical sensor and sonar sensor and positioning load change sensor that is capable providing a signal to controller to control movement of platen 44. The operation of automatic recognition is further addressed in U.S. patent application Ser. No. 11/146,685, filed on Jun. 7, 2005, entitled Cooking Apparatus and Method with Product Recognition, and U.S. patent application Ser. No. 11/375,759 filed on Mar. 15, 2006, entitled Cooking Apparatus and Method with Product Recognition, both the contents of which are entirely incorporated herein by reference. Similarly, a sensor is used to provide a signal that food product makes contact with conveyor belt. When food product initially touches conveyor belt the initial impact of the food is detected by detector and a signal is provided to second platen to commence a motive force platen toward or away from conveyor belt located above first platen.

To cook food product 38, dispenser 20 releases food product onto guide 30, which in turn falls to cooking surface 52. Cooking surface 52 is indexed to move at the proper speed with respect to dispenser 20, to ensure that food product 38 are spaced on surface 52. The positioning mechanism moves upper platen 44 toward a cooking surface 52. The detector having a sensor provides a trigger signal to the controller when the second platen contacts the food product. After determining a thickness of the food product, for example, an appropriate cook procedure is selected to cook food product 38.

A controller 500 is provided for operating the grilling apparatus 10 through a cooking cycle in which food product 38, for example, hamburger patties are advanced by the conveyor system 46 from the dispenser 20 to cooking region 40 between the platens 44, 54. Upper platen 44 is lowered to effect two-sided cooking of the hamburgers. The temperature of upper platen 44 and lower platen 54 can be can be set for the same temperature or for different temperatures. For example, the temperatures of both platens can reach approximately 150° F. to 500° F. (or any appropriate temperature for cooking food product). The controller 500 is internal to the grill and will control dispenser, upper and lower platen temperatures, holding area temperatures, conveyor drive motor (indexing), and cook timing. Controller 500 can also control motor 15 so that motor 15 is indexed to move at the same rate as cooking surface 52 of conveyor system 46 to ensure that released food product 38 is properly received and spaced beneath platens 44 and 54 for proper cooking. Alternatively, motor 15 is controlled separately and controller 500 communicates with the controller of motor 15 so that motor 15 is indexed to move at the same rate as cooking surface 52 of conveyor system 46 to ensure that released food product 38 is properly received and spaced beneath platens 44 and 54 for proper cooking.

Referring to FIG. 3, conveyor system 46 has a cook surface 52 or a series of parallel rods that are coated with a release material, such as Teflon®, to ensure that the food product 38 does not stick to surface 52 during the cooking process. The release material can be any suitable material such as a coating or surface. Preferably, the release material is a sheet of Teflon® coated fiberglass, preferably 3 milliliters thick, which can be purchased as TFE-Glass Fabric or as SRC-Glass Fabric, each is available from various distributors of industrial materials, such as McMaster-Carr of Atlanta, Ga. “Teflon®” is a registered trademark of DuPont de Nemours and Co.

Cooking surface or conveyor belt 52, of conveyor system 46, is a Teflon® coated continuous belt is driven by a drive roller internally or externally driven. Conveyor system 46 is of the indexing type. As food product 38 is being dispensed, the cooking surface 52 moves at the same rate as the food dispenser and indexes the appropriate distance to convey food to a position centered beneath upper cooking platen 44.

A chute 60 is provided at the lower edge of front roller 48 to both catch and transport cooked food product 70 from conveyor 46 to bin 80. Chute 60 is preferable coated with Teflon® or another release material to prevent cooked food product 70 from sticking to chute 60 and to allow it to fall down chute 60.

Bin 80 is provided at the lower edge of chute 60 to catch cooked food product 70. Bin 80 is inclined downwardly and forwardly to receive the hamburger patties discharged from the front end of chute 60. Preferably, bin 80 is heated to maintain the temperature of cooked food 70 in preparation for insertion into a bun or other bread product in preparation for sale or consumption. Bin 80 is supported by support arms 90 that extend from the body of griddle 10.

The grill apparatus 10 enables loading of uncooked hamburger patties or food product 38 and unloading of cooked food product 70 from the front side of the grill and avoids the necessity of providing space at the rear side of the grill for retrieving cooked hamburgers. Cooking platens 44, 54 are advantageously inclined downwardly and rearwardly to convey fluids such as water and grease to the rear waste receptacle 48 and away from the cooked hamburger patties that are discharged at the front side of the grill onto the cooked patty receiver. Chute 60 is fixed over grease management system that extends beneath cooking unit 40 and extracts grease from conveyor system 46. This avoids contamination of the chute 60 and patty magazine 20 by cooked food product 70 and also reduces the overall space required at the front of the machine for chute 60 and bin 80.

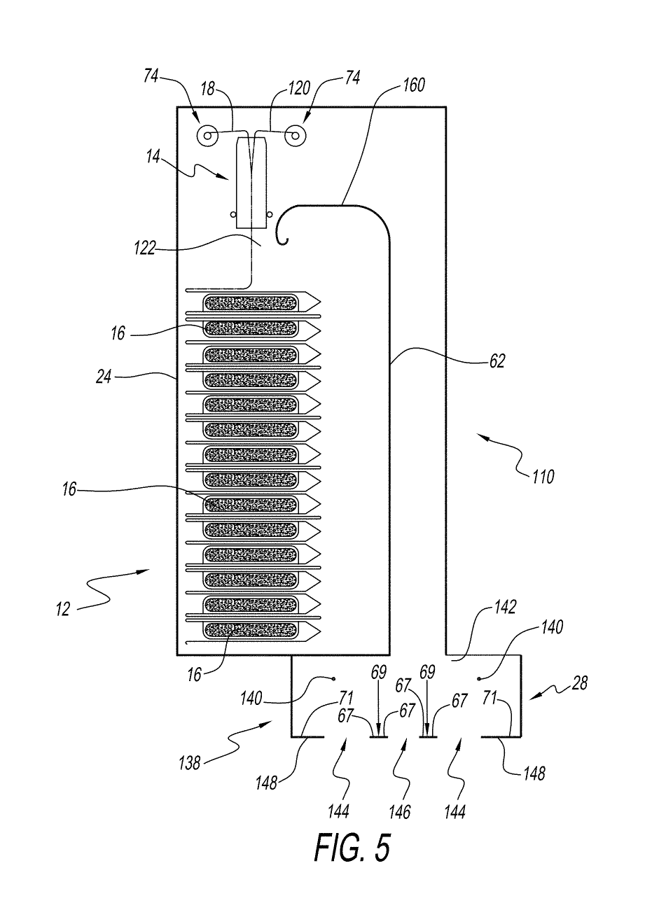

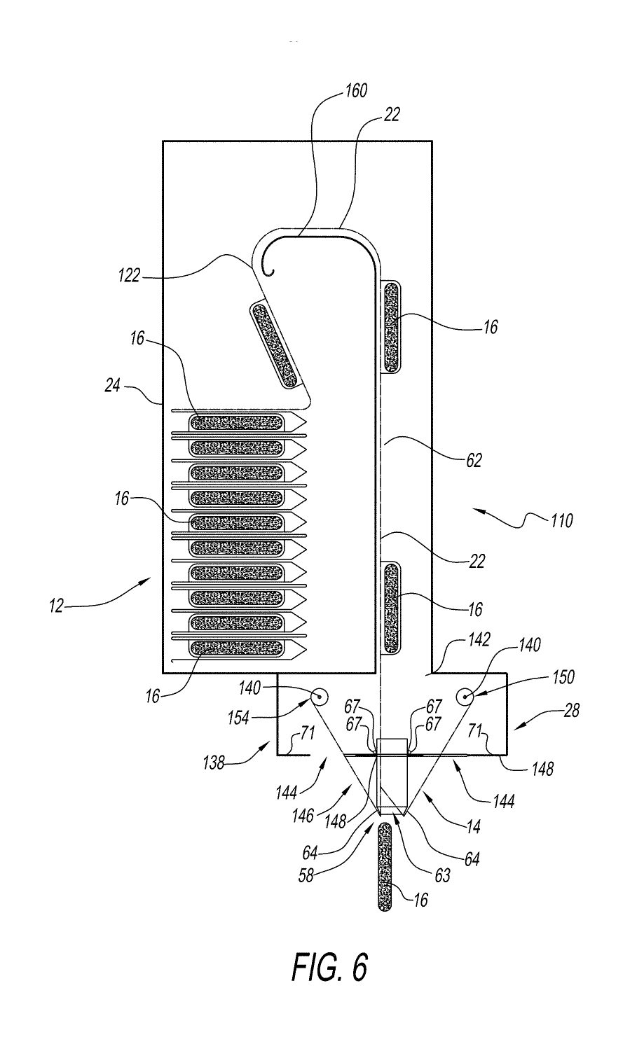

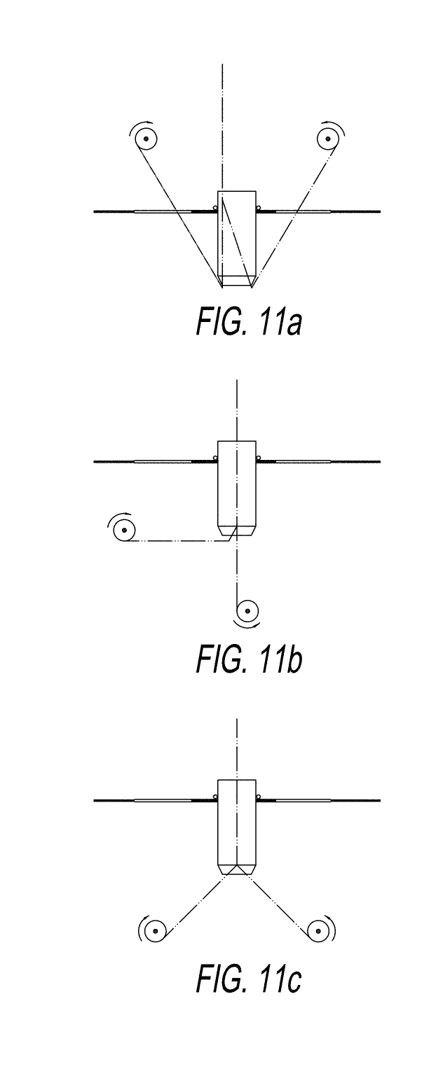

Another example of magazine 20 is described in U.S. Patent Application Publication No. 2006/0261082, filed May 16, 2006 and is shown in FIGS. 5-11. The contents of U.S. Patent Application Publication No. 2006/0261082, filed May 16, 2006 are entirely incorporated herein by reference. As best shown in FIGS. 5 and 6, the present disclosure relates to a food handling system generally indicated as 110 to store and dispense food products comprising a food storage assembly generally indicated as 12 to store the food products therein and a food dispensing assembly generally indicated as 14 to dispense the food products from the food dispensing assembly 14 of the food handling system 110.

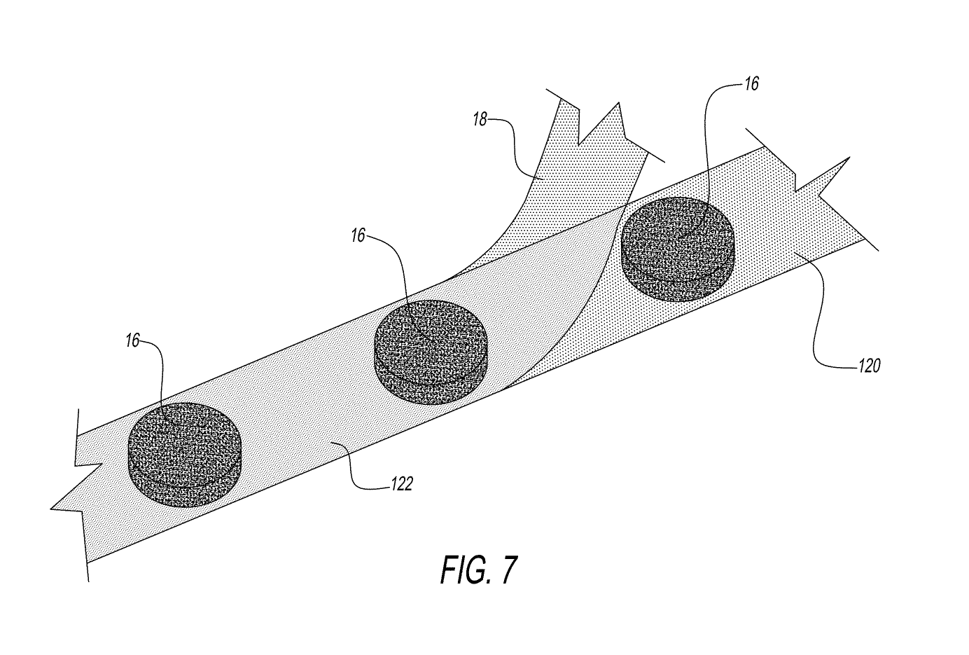

As shown in FIG. 7, the food products such as a hamburger patty 16 are packaged between a first elongated strip of flexible material or film 18 and a second elongated strip of flexible material or film 120. The first elongated strip of flexible material or film 18 and the second elongated strip of flexible material or film 120 may be sealed together by heat and/or pressure to cooperatively form a continuous laminated food strip 122 to protect the food products 16 therebetween for storage within the food storage assembly 12 until the first elongated strip of flexible material or film 18 and the second elongated strip of flexible material or film 120 are separated by the food dispensing assembly 14 to dispense the food products 16 from the food handling system 110 as described more fully hereinafter. The food products may comprise a hamburger patty 16 as shown or other meat foodstuffs such as ham, salami, fish, lamb or the like and vegetarian foodstuff such as spinach, cucumber, tomato or the like. In addition, the food products may comprise condiments such as ketchup, mustard, mayonnaise or the like.

As shown in FIGS. 5 and 6, the food products 16 are fan folded as a series of food products 16 stacked one upon another in a dispensing configuration or disposition when stored within the food storage assembly 12. As will be evident, the food products 16 are stored and dispensed onto a dish, conveyor or other surface (not shown) in a hygienic manner without handling or touching by a human operator.

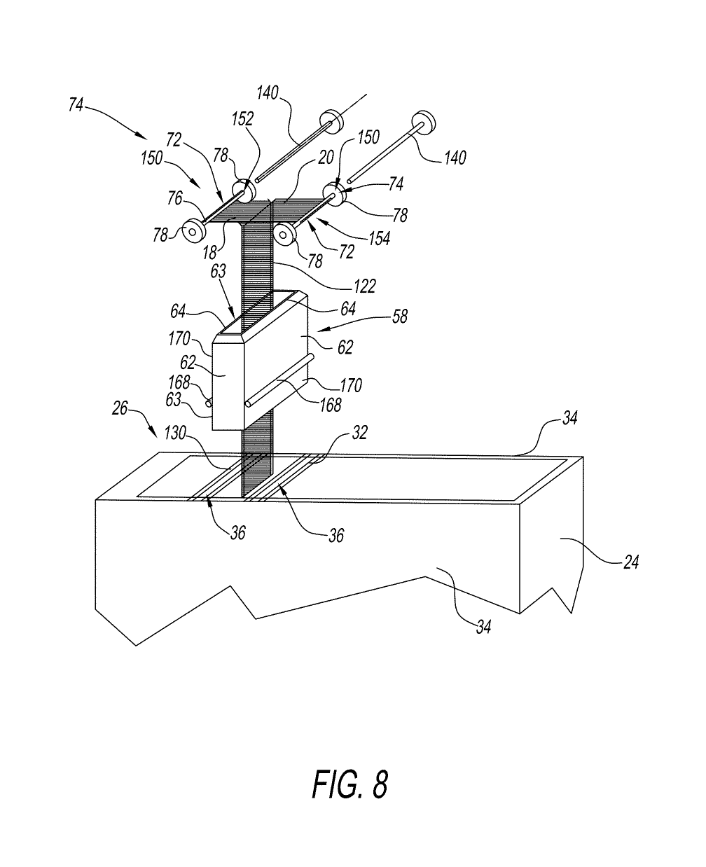

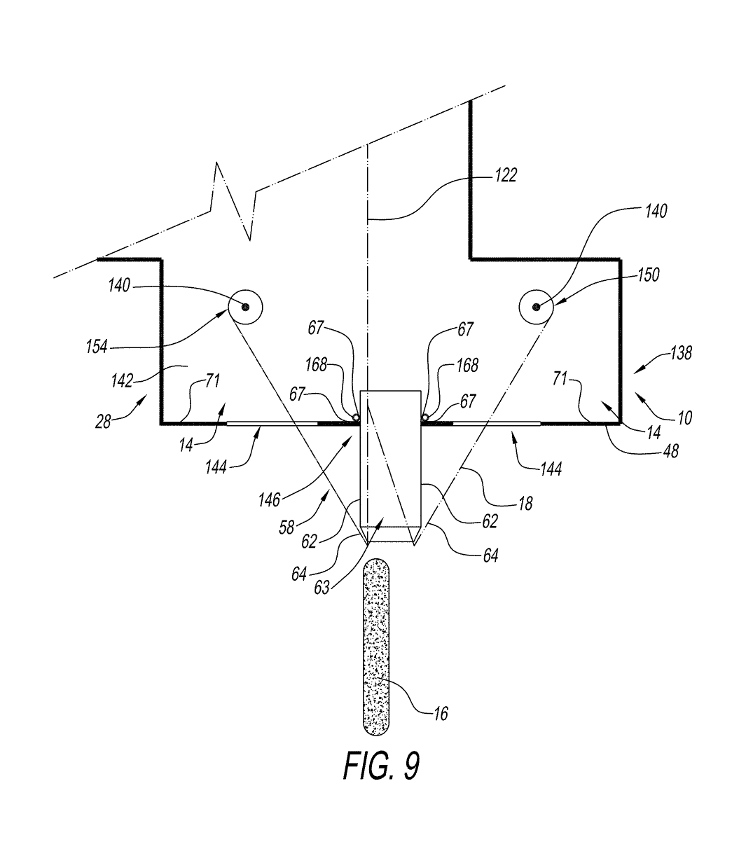

As best shown in FIGS. 5 and 6, the food storage assembly 12 comprises a hollow food product storage enclosure or carton 24 to house and support the plurality of food products 16 sealed or disposed between the first elongated strip of flexible material or film 18 and the second elongated strip of flexible material or film 120 of the continuous laminated food strip 122 stacked in the fan folded configuration. As shown in FIG. 8, a food dispensing assembly storage support generally indicated as 26 is disposed in the upper portion of the hollow food product storage enclosure or carton 24 of the food storage assembly 12 to support the food dispensing assembly 14 before use. As shown in FIGS. 5 and 6, a food dispensing assembly support generally indicated as 28 is disposed on the lower portion thereof to operatively support the food dispensing assembly 14 when deployed to separate the first elongated strip of flexible material or film 18 and the second elongated strip of flexible material or film 120 to dispense the food products 16 serially and individually from the food dispensing assembly 14 of the food handling system 110 as best shown in FIGS. 6 and 9.

As best shown in FIG. 8, the food dispensing assembly storage support 26 comprises a first food dispensing assembly support member 130 and a second food dispensing assembly support member 32 extending between the upper portion of opposite side walls each indicated as 34 of the hollow food product storage enclosure or carton 24. The first food dispensing assembly support member 130 and the second food dispensing assembly support member 32 each includes a groove or channel 36 to receive and support a portion of the food dispensing assembly 14 as described more fully hereinafter.

As shown in FIGS. 5, 6 and 9, the food dispensing assembly support 28 comprises a food dispensing assembly support housing generally indicated as 138 having a pair of rotatably mounting members or pins each indicated as 140 mounted to a substantially vertically disposed support wall or member 142 and a pair of film separation slots or openings each indicated as 144 and a centrally dispensed laminated strip opening 146 formed through a substantially horizontally disposed lower wall 148 extending outwardly from the substantially vertically disposed support member 142 to receive the first elongated strip of flexible material or film 18 and the second elongated strip of flexible material or film 120, and the continuous laminated food strip 122 respectively when the food dispensing assembly 14 is operatively mounted on the food dispensing assembly support 28 as described more fully hereinafter.

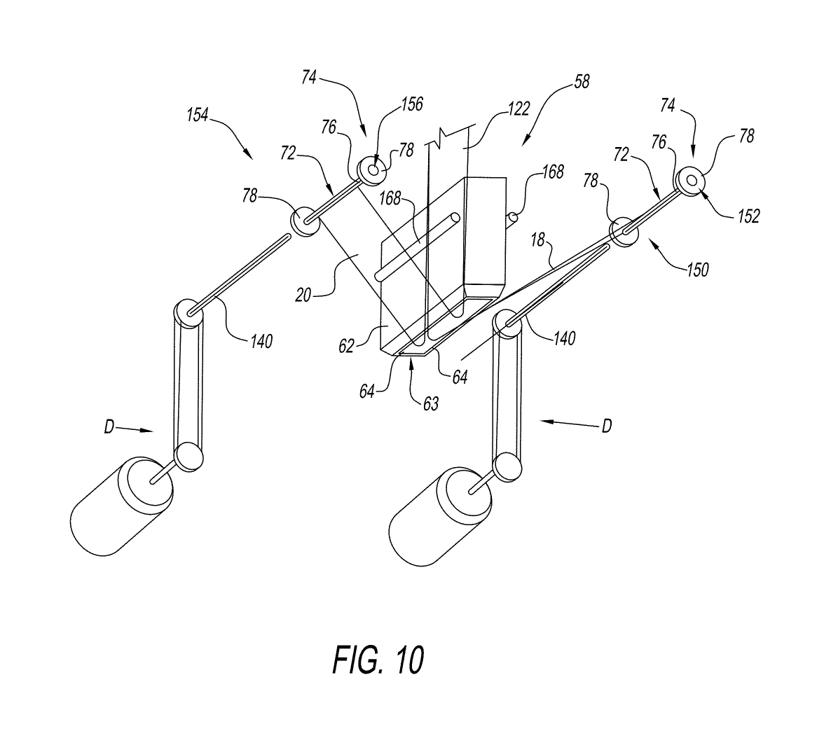

As best shown in FIGS. 9 and 10, the food dispensing assembly 14 comprises a first film strip reel or film take-up device generally indicated as 150 including a centrally disposed pin mounting channel 152 coupled to the leading end portion of the first elongated strip of flexible material or film 18 and a second film strip reel or film take-up device 154 including a centrally disposed pin mounting channel 156 coupled to the leading end portion of the second elongated strip of flexible material or film 120 such that when the first film strip reel or film take-up device 150 and the second film strip reel or film take-up device 154 are mounted on the corresponding rotatable mounting member or pin 140 extending through centrally disposed pin mounting channels 152 and 156 respectively.

The food dispensing assembly 14 further includes a food strip directional control generally indicated as 58 mounted to the substantially horizontally disposed lower wall 148 of the food dispensing assembly support 138 to change the direction of travel of the continuous laminated food strip 122 directed to the food dispensing assembly 14 by a laminated food strip guide comprising an upper arcuate guide member 160 and a substantially vertical guide member 62 disposed within the food storage assembly 12.

The food strip directional control 58 comprises a pair of directional control members each indicated as 62 disposed in spaced relationship to cooperatively form a film slot or channel 63 to receive the continuous laminated food strip 122 and the food products 16 therethrough each directional control member 62 includes a directional control surface 64 to engage the outer surfaces of the first elongated strip of flexible material or film 18 and second elongated strip of flexible material or film 120 when the first film strip reel or film take-up device 150 and the second film strip reel or film take-up device 154 are mounted on the corresponding rotatable mounting member or pin 140.

When so configured, as shown in FIG. 10, a drive means D comprising a motor and belt or suitable mechanism rotates the rotatable mounting members or pins 140 rotating the corresponding first film strip reel or film take-up device 150 and the second film strip reel or film take-up device 154 thereby separating the first elongated strip of flexible material or film 18 and the second elongated strip of flexible material or film 120 allowing the food products 16 to drop or fall onto a conveyor, dish or other surface (not shown).

The preferred angle for redirecting the first elongated strip of flexible material or film 18 and the second elongated strip of flexible material or film 120 is at least 170 degrees. However, the disclosure contemplates that at least either the first elongated strip of flexible material or film and the second elongated strip of flexible material or film 120 is redirected at least about 90 degrees.

As best shown in FIGS. 6 and 9, the food strip directional control 58 of the food dispensing assembly 14 are formed on the lower portions of side walls 170 that are partially disposed in the centrally disposed laminated strip opening 146 with an assembly support member 168 attached or formed on opposite side walls 170 to engage the upper surface 71 of the substantially horizontally disposed lower wall 148 of the food dispensing assembly support housing 138 on opposite sides of the centrally disposed laminated strip opening 146. As shown in FIGS. 6 and 9, each assembly support member 168 may be disposed between a corresponding pair of retention members each indicated as 67 to cooperatively form an assembly support member receiving channel 69.

Outer end portions of the first elongated strip of flexible material or film 18 and the second elongated strip of flexible material or film 120 are attached or coupled to the first film strip reel or film take-up device 150 and the second film strip reel or film take-up device 154 respectively by an adhesive or through a film slot 72 described hereinafter when deployed. The first film strip reel or film take-up device 150 and the second film strip reel or film take-up device 154 each comprises a spool generally indicated as 74 including a film strip cross-member 76 to receive the first elongated strip of flexible material or film 18 or the second elongated strip of flexible material or film 120 of the continuous laminated food strip 122 having a film retainer element or member 78 disposed on opposite end portions thereof to retain the first elongated strip of flexible material or film 18 or the second elongated strip of flexible material or film 120 of the continuous laminated food strip 122 thereon during the separation process. Each film strip cross-member 76 may include the film slot 72 to receive the outer portion of the corresponding first elongated strip of flexible material or film 18 or second elongated strip of flexible material or film 120.

When the food handling system 110 is stored or refrigerated, each film strip cross-member 76 is disposed within the corresponding groove or channel 36 of the corresponding food dispensing assembly support member 32.

The continuous laminated food strip 122 disposed in the food storage assembly 12 is placed in the cold storage. As previously described, the food dispensing assembly 14 may be at least partially stored with the food storage assembly 12, the food dispensing assembly 14 is disposed at the lower portion of the hollow food product storage enclosure or carton 24. The outer-end portions of the laminated food strips 18 and 120 are connected or coupled to the film take-up devices 150 and 154. When the first elongated strip of flexible material or film 18 and the second elongated strip of flexible material or film 120 of the continuous laminated food strip 122 is reversed backwards at an angle over the first directional control surface 64 and second directional control surface 66 respectively the first elongated strip of flexible material or film 18 and the second elongated strip of flexible material or film 120 of the continuous laminated food strip 122 are separated allowing the food products 16 to separate from the film of the continuous laminated food strip 122.

This results in unpackaging of the food products 16 from the laminated food strip 122. As this delamination takes place, the delamination food product 16 passes onto the conveyor belt or other receiving surface (not shown). Thus, delaminated/unpackaged food products 16 under aseptic conditions may be fed to a grill or conveyor oven or any other heat source directly for the purpose of cooking, without the food being even touched by the cooking staff.

The present disclosure having been thus described with particular reference to the preferred forms thereof, it will be obvious that various changes and modifications may be made therein without departing from the spirit and scope of the present disclosure as defined in the appended claims.

What is claimed is:

1. A cooking apparatus comprising:
a conveyor system having a continuous cooking surface;
a dispenser disposed proximate said continuous cooking surface;
a guide disposed between said dispenser and said continuous surface to guide food product released from said dispenser to said continuous cooking surface; and
at least one platen proximate said cooking surface to cook said food product.

2. The cooking apparatus of claim 1, wherein said conveyor system is an indexing type conveyor system.

3. The cooking apparatus of claim 2, wherein said conveyor system is indexed to move at the same rate as said dispenser to receive dispensed food product.

4. The cooking apparatus of claim 1, wherein said guide is at an angle relative to said cooking surface and said dispenser; said angle permits said food product to be received by said cooking surface.

5. The cooking apparatus of claim 1, wherein said at least one platen proximate said cooking surface is two platens proximate said cooking surface, wherein said two platens are in spaced apart relationship to one another to receive the food product therebetween for cooking.

6. The cooking apparatus of claim 5, wherein one of said two platens moves toward or away from the other of the two platens.

7. The cooking apparatus of claim 5, further comprising a positioning mechanism that moves one of said two platens toward and/or away from the other of the two platens; a detector disposed to provide a signal as one of said two platens makes contact with a food product disposed on said cooking surface; and a controller that responds to said signal to move said positioning mechanism and/or said second platen into a cooking position in relation to said food product.

8. The cooking apparatus of claim 7, wherein said detector comprises a device that is selected from the group consisting of: micro switch, proximity sensor, touch sensor, strain sensor, thermal sensor, optical sensor and sonar sensor.

9. The cooking apparatus of claim 1, wherein said two platens cook said food product based a predetermined cooking procedure.

10. A cooking apparatus comprising:
a first platen and a second platen disposed in spaced apart relation to one another for cooking a food product;
a conveyor system having a continuous cooking surface, said continuous cooking surface moves between said first platen and said second platen; and
a dispenser disposed proximate said continuous cooking surface,
wherein said conveyor system is indexed to move said continuous cooking surface at a same rate as said dispenser dispenses food product on cooking surface.

11. The cooking apparatus of claim 10, wherein said conveyor system is indexed to move said continuous surface at a rate such that consistent spacing is between said food product.

12. The cooking apparatus of claim 10, further comprising a positioning mechanism that moves said second platen toward and/or away from said first platen.

13. The cooking apparatus of claim 10, wherein said food product is cooked as it moves between said first platen and said second platen.

14. The cooking apparatus of claim 10, wherein said food product is deposited on a receiving tray after being cooked.

15. The cooking apparatus of claim 14, wherein said receiving tray is a heatable receiving tray.

16. A method of cooking using a cooking apparatus comprising:
dispensing a food product from a food dispenser;
receiving said food product onto a continuous cooking surface of a conveyor mechanism; and
moving said cooking surface between a first platen and a second platen to cook said food product; and
wherein said conveyor mechanism is indexed to move at a rate equal to a rate of said food dispenser to index the appropriate distance to convey said food product to a position centered beneath one of said first platen or said second platen.

17. The method of claim 16, further comprising a guide disposed between said dispenser and said continuous cooking surface to guide said food product released from said dispenser to said continuous cooking surface.

18. The method of claim 16, further comprising moving one of said first platen or said second platen relative to said food product based upon a detected quality of said food product.

19. The method of claim 16, wherein said detected quality is one of a height or a thickness of said food product.

20. The method of claim 19, wherein based upon said detected quality a cooking procedure is selected for cooking said food product.
